(19) United States
(12) Patent Application Publication
(10) Pub. No.: US 2026/0360856 A1
(43) Pub. Date: Nov. 12, 2026

(54) BATTERY SYSTEM AND ELECTRIC VEHICLE INCLUDING THE SAME

(71) Applicant: Samsung SDI Co., Ltd., Yongin-si (KR)

(72) Inventors: Martin BLODER, Sinabelkirchen (AT); Mike RABANSER, Graz (AT)

(21) Appl. No.: 19/422,876

(22) Filed: Dec. 17, 2025

(30) Foreign Application Priority Data
May 6, 2025 (EP) 25174556.8

(51) Int. Cl. H01M 10/6556; H01M 10/04; H01M 10/613; H01M 10/625; H01M 10/647; H01M 10/6554; H01M 10/6568; H01M 50/209; H01M 50/249; B60L 50/64

(52) U.S. Cl. CPC H01M 10/6556; H01M 10/0481; H01M 10/613; H01M 10/625; H01M 10/647; H01M 10/6554; H01M 10/6568; H01M 50/209; H01M 50/249; B60L 50/64; H01M 2220/20

(57) ABSTRACT

A battery system includes: a plurality of battery cells arranged in a cell stack; a cell stack frame accommodating the cell stack and exerting a pressure onto the cell stack; and a cooling structure including a plurality of cooling plates arranged between the battery cells. Each cooling plate includes: two plate elements having a cooling chamber therebetween configured for passage of coolant; and a compression structure arranged inside the cooling chamber. The compression structure includes a spring element interconnecting the two plate elements to each other and a connection portion connecting the spring element to at least one of the plate elements. The spring elements have a corrugated shape and are configured to be elastically deformed in response to compression forces acting on the plate elements, and the connection portions are configured to be plastically deformed in response to compression forces acting on the plate elements.

### CROSS-REFERENCE TO RELATED APPLICATION

The present application claims priority to and the benefit of European Patent Application No. 25174556.8, filed on May 6, 2025, in the European Patent Office, the entire disclosure of which is incorporated herein by reference.

### BACKGROUND

### 1. Field

Aspects of embodiments of the present disclosure relate to a battery system and an electric vehicle including the same.

### 2. Description of the Related Art

Recently, vehicles for transportation of goods and peoples have been developed that use electric power as a source for motion. An electric vehicle is an automobile that is propelled, permanently or temporarily, by an electric motor using energy stored in rechargeable (or secondary) batteries. The electric vehicle may be solely powered by batteries (a so-called Battery Electric Vehicle (BEV)) or may include a combination of an electric motor and, for example, a conventional combustion engine (a so-called Plugin Hybrid Electric Vehicle (PHEV)). BEVs and PHEVs use high-capacity rechargeable batteries, which are designed to provide power for propulsion for sustained periods of time.

Generally, a rechargeable (or secondary) battery cell includes an electrode assembly including a positive electrode, a negative electrode, and a separator interposed between the electrodes. A solid or liquid electrolyte allows for movement of ions during charging and discharging of the battery cell. The electrode assembly is located in a casing (or case) and electrode terminals, which are positioned on the outside of the casing, establish an electrically conductive connection to the electrodes. Common battery cell formats include, for example, cylindrical, prismatic, and pouch.

A battery module is formed of (or includes) a plurality of battery cells connected together in series or in parallel. The battery module is formed by interconnecting the electrode terminals of the plurality of battery cells, with the number and connection arrangement thereof depending on a desired amount of power, to realize a relatively high-power rechargeable battery.

Battery modules can be constructed either in a block design or a modular design. In the block design, each battery cell is coupled to a common current collector structure and a common cell management unit and accommodated in a housing. In the modular design, pluralities of battery cells are connected together to form submodules, and several submodules are connected together to form the battery module. In automotive applications, battery systems may include a plurality of battery modules connected together in series to provide a desired voltage.

A battery pack is a set of any number of (usually identical) battery modules and/or single (e.g., individual) battery cells. The battery modules or, respectively, the battery cells, may be configured in a series, parallel, or a mixture of both to provide the desired voltage, capacity, and/or power density. Components of a battery pack include the individual battery modules and interconnects, which provide electrical conductivity between the battery modules.

Mechanical integration of a battery pack is achieved by appropriate mechanical connections between the individual components, for example, between the battery modules, and between them and a supporting structure of the vehicle. These connections should remain functional and safe throughout the average service life of the battery system. Further, installation space and interchangeability specifications should be met, especially in mobile applications.

Mechanical integration of battery modules may be achieved by providing a carrier framework and by positioning the battery modules thereon. Fixing the battery cells or battery modules may be achieved by fitted depressions in the framework or by mechanical interconnectors, such as bolts or screws. In some cases, the battery modules are confined by fastening side plates to lateral sides of the carrier framework. Further, cover plates may be fixed atop and below the battery modules.

The carrier framework of the battery pack is mounted to a carrying structure of the vehicle. When the battery pack is to be fixed at the bottom of the vehicle, the mechanical connection may be established from the bottom side by, for example, bolts passing through the carrier framework of the battery pack. The framework is generally made of aluminum or an aluminum alloy to reduce the overall weight of the construction.

A conventional battery system, despite any modular structure, usually includes a battery housing that acts as an enclosure to seal the battery system against the environment and provides structural protection of the battery system's components. Housed battery systems are usually mounted as a whole (e.g., as a single unit) into their application environment, such as an electric vehicle. Thus, the replacement of defective system parts, for example, a defective battery submodule, requires dismounting the entire battery system and removal of its housing first. Even defects of small and/or cheap system parts may require dismounting and replacement of the entire battery system and its separate repair. Because high-capacity battery systems are expensive, large, and heavy, the procedure is burdensome, and the storage, for example, in the mechanic’s workshop, of the bulky battery system is difficult.

As the location for the active and passive components of a battery system, the battery housing plays an important role in the functionality, safety, and service life of the energy storage system. The battery housing protects the sensitive components from harmful environmental influences, such as water, moisture, and dust and is, therefore, crucial for long-term safe and reliable operation. Because traction batteries are typically located outside the vehicle cabin, usually in (or under) the floor area, the housing is directly exposed to extreme environmental conditions, such as temperature, humidity, splash water, salt spray, dust, and stone chipping or impacts. High mechanical stability and corrosion resistance are therefore essential, even under aggressive external conditions. In addition to the environmental influences, which primarily affect the surface of the housing or the tightness of the housing, the internal and external fastening systems are of particular importance under vehicle operating conditions.

An active or passive thermal management system may be included to provide thermal control of the battery pack to safely use the at least one battery module by efficiently emitting, discharging, and/or dissipating heat generated by its rechargeable batteries. If the heat emission, discharge, and/or dissipation is not sufficiently performed, temperature deviations may occur between respective battery cells, such that the at least one battery module may no longer generate a desired (or designed) amount of power. In addition, an increase of the internal temperature can lead to abnormal reactions occurring therein, and thus, charging and discharging performance of the rechargeable battery deteriorates and the life-span of the rechargeable battery is shortened. Thus, cell cooling for effectively emitting, discharging, and/or dissipating heat from the battery cells is important.

The effective management of thermal energy is essential for the optimal functioning and longevity of lithium-ion batteries in mobile applications because the ability to regulate temperature is crucial for maintaining full performance and operational readiness in a wide range of conditions. Thermal management encompasses both cooling and heating operations. Given the considerable diversity of lithium-ion battery variants, characterized by differences in cell chemistry and structure, thermal management should be tailored to the specific requirements of each variant. A similar situation pertains to regard to the numerous different vehicle applications, which encompass a range of vehicles from small city cars to sports cars, as well as vehicles with mild hybridization and purely electric vehicles. Furthermore, integration into the vehicle's thermal circuits is of significant importance.

In the case of air cooling, cooling air flows around the battery cells, thereby cooling the freely accessible surfaces. Because this type of cooling does not necessitate direct thermal contact with the battery cells, the interface to the cooling system is relatively straightforward. Nevertheless, the installation space required for the cooling air ducts between the battery cells is considerable, and the cooling effectiveness, for example, the homogeneity of cell cooling, is often inadequate. In contrast, cooling methods that establish thermal contact with the battery cell and dissipate the heat via heat conduction are more effective than air cooling in terms of cooling efficacy. Nevertheless, the design of the thermal contact presents different challenges. The interface to the cooling system is more complex because the cooling apparatus is in direct contact with the electrical components of the battery cell. In the case of cells having a low height and sufficiently thick cell walls, it is often sufficient to simply contact the bottom of the battery cells via a cooling plate. Should this prove inadequate, supplementary heat conduction elements must be incorporated between the battery cells to facilitate the transfer of heat to the cooling plate. However, this results in a heavier and more expensive cooling system. The use of fluid-conducting cooling plates between the battery cells has been demonstrated to be effective because the heat conduction path from the interior of the battery cell to the cooling fluid is relatively short, resulting in a high degree of temperature homogeneity within the battery cell. An alternative approach to cooling is arrester cooling. In this method, the interior of the battery cell is cooled directly via the electrodes. Pouch cells may be well-suited for this type of cooling because they have flat and, therefore, relatively easy-to-contact terminals. The waste heat from the battery cells is directed into a cooling plate. There, either cooling water or an evaporating refrigerant absorbs the heat and dissipates it to the environment via the vehicle's cooling or refrigeration system.

Exothermic decomposition of cell components may lead to a so-called thermal runaway. Generally, a thermal runaway describes a process that accelerates due to increased temperature, in turn releasing energy that further increases temperature. Thermal runaway occurs in situations when an increase in temperature changes the conditions in a way that causes a further increase in temperature, often leading to a destructive result. In rechargeable battery systems, thermal runaway is associated with strong exothermic reactions that are accelerated by temperature rise. In thermal runaway, the battery cell temperature rises incredibly fast, and the stored energy is released very suddenly. In extreme cases, thermal runaway can cause battery cells to explode and start fire. In minor cases, thermal runaway can cause battery cells to be irreparably damaged.

When a battery cell is heated above a critical temperature, the battery cell can transition into the thermal runaway. Generally, temperatures outside of the safe region on either the low or high side may lead to irreversible damage to the battery cell and, therefore, may possibly trigger thermal runaway. Thermal runaway may also occur due to an internal or external short circuit of the battery cell or poor battery maintenance. For example, overcharging or rapid charging may lead to thermal runaway.

During thermal runaway, the failed battery cell may reach a temperature exceeding about 700° C. Further, large quantities of hot gas are ejected from inside of the failed battery cell through a venting opening in a cell housing into the battery pack. The main components of the vented gas are H₂, CO₂, CO, electrolyte vapor, and other hydrocarbons. The vented gas is therefore flammable and potentially toxic. The vented gas also causes a gas-pressure to increase inside the battery pack. In the worst case, the high temperatures lead to the process spreading to neighboring cells and fire in the battery pack. At this stage, the fire is hard to extinguish.

The battery cells of a battery pack may be arranged to form a cell stack by stacking the battery cells onto each other or arranging the battery cells in a row and placing the cell stack within a cell stack frame. Neighboring battery cells of such a cell stack may be distanced from (e.g., spaced from) one another via cell spacers. To ensure optimal operation of the battery cells over their lifetime, a reference (or predefined) pressure may be exerted onto the battery cells by the cell stack frame to compensate for possible production tolerances and swelling of the battery cells.

Current battery systems typically include cell stack frames with end plates exerting pressure onto the cell stack, in some cases via an end spacer, with a rigid linear or progressive elastic pressure characteristic. Such a rigid linear or progressive elastic pressure characteristic may be susceptible to length or positioning deviations because a small displacement may cause a steep increase or decrease of force applied on the cell stack, which in turn may reduce the stacks performance. To mitigate this, very precise and, therefore, expensive production tolerances have to be met, or other costly and intricate ways of adjusting the cell stacks pre-tension via positioning of the end plate during assembly have to be implemented. Such cell stack frames may not be able to ensure that the right amount of pressure is applied to the cell stack over its entire lifetime.

### SUMMARY

According to embodiments of the present application, a battery system that ensures suitable pressure conditions as well as temperatures for optimal operation of the battery cells over their entire lifetime is provided.

The present disclosure is defined by the appended claims and their equivalents. The description that follows is subject to this limitation. Any disclosure lying outside the scope of the claims and their equivalents is intended for illustrative as well as comparative purposes.

According to an embodiment, a battery system includes a plurality of battery cells in a cell stack, a cell stack frame accommodating the cell stack and exerting a pressure onto the cell stack, a cooling structure including a plurality of cooling plates arranged between adjacent ones of the battery cells. Each cooling plate includes two plate elements with a cooling chamber in-between for the passage of coolant and a compression structure arranged inside the cooling chamber. The compression structure includes one or more spring elements interconnecting the plate elements. The spring elements have a corrugated shape and are configured to be elastically deformed in response to compression forces acting on the plate elements. The compression structure further includes connection portions connecting the spring elements to the plate elements, the connection portions being configured to be plastically deformed in response to compression forces acting on the plate elements.

According to an embodiment, the cooling structure further includes curved connecting elements extending about (or around) end sides of the battery cells and interconnecting neighboring cooling plates of the plurality of cooling plates such that the cooling structure has a meandering form.

According to an embodiment, the cell stack frame includes an end plate exerting pressure onto the cell stack.

According to an embodiment, the cooling structure further includes a fluid inlet element arranged at a first end of the cell stack and a fluid outlet element arranged a second end of the cell stack. The cooling structure is configured for the passage of the coolant from the fluid inlet element, through the cooling chamber of the cooling plates, and out of the fluid outlet element.

According to an embodiment, the cooling plates are extruded plates and/or are made of aluminum.

According to an embodiment, the spring elements include V-shaped springs interconnecting the plate elements, and the V-shaped springs each include two legs with a corrugated shape. The legs are configured to be elastically deformed in response to compression forces acting on the plate elements, and the connection portions connect the legs to the plate elements.

According to an embodiment, the V-shaped springs are arranged one after the other in the same orientation.

According to an embodiment, the V-shaped springs are arranged in pairs of two with their open ends facing (or against) each other.

According to an embodiment, the corrugated shape of the V-shaped springs is configured such that when the cooling plate is fully compressed, the two legs of the V-shaped springs are nested inside each other while cooling channels through the cooling chamber are partially maintained inside the compressed cooling plate.

According to an embodiment, the spring elements include a spring plate having a corrugated shape, and a main extension plane of the spring plate extends substantially parallel to the plate elements.

According to an embodiment, the plate elements are configured to bulge outwardly in a relaxed state and to be flattened in a compressed state to homogenize the pressure applied by the plate elements to adjacent ones of the battery cells.

According to an embodiment, an electric vehicle includes the battery system.

Further aspects, features, and embodiments of the present disclosure can be learned from the dependent claims or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a perspective view of a battery system according to an embodiment.

FIG. 2 is a top view of the battery system shown in FIG. 1.

FIG. 3 is a perspective view of the battery system shown in FIG. 1 with one of the end plates removed.

FIG. 4 illustrates a meandering cooling structure of the battery system shown in FIG. 1.

FIGS. 5A-5D illustrate a cross-section of a cooling plate of the cooling structure and the area A in FIG. 5A of this cooling plate in three different stages of compression according to an embodiment.

FIGS. 6A-6D illustrate a cross-section of a cooling plate of the cooling structure and the area A in FIG. 6A of this cooling plate in three different stages of compression according to another embodiment.

FIGS. 7A-7D illustrate a cross-section of a cooling plate of the cooling structure and the area A in FIG. 7A of this cooling plate in three different stages of compression according to another embodiment.

FIG. 8 is a diagram describing a force to elongation (e.g., stack length) ratio for the battery systems according to embodiments of the present disclosure.

### DETAILED DESCRIPTION

Reference will now be made, in detail, to embodiments, examples of which are illustrated in the accompanying drawings. Aspects and features of the embodiments, and implementation methods thereof, will be described with reference to the accompanying drawings. The present disclosure, however, may be embodied in various different forms and should not be construed as being limited to the embodiments illustrated herein. Rather, these embodiments are provided as examples so that this disclosure will be thorough and complete and will fully convey the aspects and features of the present disclosure to those skilled in the art.

Accordingly, processes, elements, and techniques that are not considered necessary to those having ordinary skill in the art for a complete understanding of the aspects and features of the present disclosure may not be described or may be only briefly described. In the drawings, the relative sizes of elements, layers, and regions may be exaggerated for clarity. The same reference numerals designate the same elements.

As used herein, the term "and/or" includes any and all combinations of one or more of the associated listed items. Expressions, such as “at least one of”, when preceding a list of elements, modify the entire list of elements and do not modify the individual elements of the list. Further, the use of “may” when describing embodiments of the present disclosure refers to “one or more embodiments of the present disclosure." In the following description of embodiments of the present disclosure, the terms of a singular form may include plural forms unless the context clearly indicates otherwise. For example, the expression "at least one of a, b, or c" indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms "substantially," "about," and similar terms are used as terms of approximation and not as terms of degree, and are intended to account for the inherent variations in measured or calculated values that would be recognized by those of ordinary skill in the art.

It will be understood that although the terms "first" and "second" are used to describe various elements, these elements should not be limited by these terms. These terms are only used to distinguish one element from another element. For example, a first element may be named a second element and, similarly, a second element may be named a first element, without departing from the scope of the present disclosure.

It will be further understood that the terms “include,” “comprise,” “including,” or “comprising” specify a property, a region, a fixed number, a step, a process, an element, a component, and a combination thereof but do not exclude other properties, regions, fixed numbers, steps, processes, elements, components, and combinations thereof.

The term “consisting essentially of” means that specific further components can be present, namely those not materially affecting the essential characteristics of a composition.

It will also be understood that when a film, a region, or an element is referred to as being "above" or "on" another film, region, or element, it can be directly on the other film, region, or element, or intervening films, regions, or elements may also be present.

Herein, the terms “upper” and “lower” are defined according to the z-axis. For example, the upper cover is positioned at the upper part of the z-axis, whereas the lower cover is positioned at the lower part thereof. In the drawings, the sizes of elements may be exaggerated for clarity. For example, in the drawings, the size or thickness of each element may be arbitrarily shown for illustrative purposes, and thus the embodiments of the present disclosure should not be construed as being limited thereto.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Also, any numerical range disclosed and/or recited herein is intended to include all sub-ranges of the same numerical precision subsumed within the recited range. For example, a range of "1.0 to 10.0" is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

According to an embodiment of the present disclosure, a battery system is provided including a plurality of battery cells, for example, prismatic or pouch type battery cells. The battery cells are arranged to form (e.g., in the form of) a cell stack, for example, by stacking the battery cells onto each other or arranging the battery cells in a row. The cell stack may form one or more battery packs. The cell stack is disposed inside (or accommodated in) a cell stack frame. The cell stack frame exerts a pressure onto the cell stack. For example, the cell stack frame may include at least one end plate that exerts the pressure. The cell stack frame may include two end plates and two side walls connecting the end plates, and one or both of the end plates may exert the pressure onto the cell stack. The cell stack arranged inside the cell stack frame may be delimited on four sides by the end plates and side walls. The cell stack frame may further include a top cover and a bottom cover such that the cell stack may be delimited on all six sides. The end plate may be fixed to the side walls (and/or the top cover and bottom cover) by, for example, being riveted or screwed. The end plate may be rigid, that is, non-deformable. The cell stack frame may delimit the cell stack to an outside, for example, to an environment of the cell stack. The end plate may form an outer delimitation of the cell stack frame. Also, the other end plate and/or the side walls may form the outer delimitation of the cell stack frame. In other words, the cell stack frame, for example, the two end plates and two side walls, may delimit an interior space of the cell stack frame from the exterior, the interior space being where the cell stack is arranged.

The battery system further includes a cooling structure. The cooling structure includes multiple cooling plates and is configured to cool the battery cells via the cooling plates. The cooling plates are arranged along the stacking direction, same as the battery cells, and are arranged, for example, between each pair of battery cells. In other words, a single battery cell may be disposed in-between two cooling plates. The cooling plates and battery cells may be arranged alternatingly in a one-to-one-relationship. The cooling plates may form cell spacers distancing neighboring battery cells from each other. In another embodiment, the cooling plates may be arranged such that, along the stacking direction, a cooling plate is provided every other or every second battery cell. For example, two battery cells may be disposed in-between two cooling plates. In another embodiment, three or more battery cells may be disposed in-between two cooling plates. The cooling plates may form part of the cell stack and are compressed by the cell stack frame along with the battery cells. In other words, the cell stack frame exerts pressure not only onto the battery cells but also onto the cooling plates disposed in-between the battery cells. Each cooling plate includes two plate elements. A first plate element from among the two plate elements may face and contact a first battery cell from among the plurality of battery cells, and a second plate element from among the two plate elements may face and contact a second battery cell from among the plurality of battery cells. Each cooling plate has a cooling chamber through which a coolant, such as a cooling fluid, may be passed (or fed through), that is, pumped through, to cool the cooling plate and, thus, the adjacent battery cells during regular operation of the battery system. The cooling structure may ensure that the battery cells are kept within a designed temperature range for regular operation.

Further, according to embodiments of the present disclosure, the cooling plates each include a compression structure disposed inside the cooling chamber. The compression structure is configured to deform based on an external pressure or force acting on the two plate elements. The cooling plates are, therefore, deformable. The compression structure includes one or more spring elements that interconnect the plate elements. Each of the spring elements has a corrugated shape. For example, the spring elements have a wrinkled or creased shape. For example, the spring elements have a meander or have a meandering form. This is to flatten/reduce the spring characteristic of the springs. The spring elements are configured to be elastically deformed in response to compression forces acting on the plate elements. Further, the compression structure includes connection portions, which connect the spring elements to the plate elements. The connection portions are configured to be plastically deformed in response to compression forces acting on the plate elements.

According to embodiments of the present disclosure, the compression structure is designed such that it is both elastically and plastically deformed in response to compression forces acting on the plate elements of the cooling plate. For example, the compression structure – and therefore the cooling plate – is elastically and plastically deformable or configured to be elastically and plastically deformed. The compression structure may be elastically deformable due to the spring elements having a corrugated shape. The elastic deformation effectively compensates for cell breathing, for example, for the variation in battery cell thickness due to charging and discharging of the battery cells. In other words, the spring elements may have a corrugated shape to be elastically deformed by cell breathing of the battery cells. The compression structure is plastically deformable due to the connection portions, at least within an operational pressure range of the battery cells. That is, in the connection portions, the bending stress is highest such that plastic deformation occurs therein so that the battery system may compensate for cell thickness tolerances. In other words, the cooling plate includes the connection portions between the spring elements and the outer plates to be plastically deformed to compensate for cell thickness tolerances within an operational pressure range of the battery cells. Such cell thickness tolerances may occur due to cell ageing.

Thus, the cooling plate has, due to the compression structure, an elastic-plastic deformation characteristic. In other words, the compression structure is designed such that when the cell stack is exposed to an increasing compression force, for example, due to cell breathing and an aging-related expansion of the battery cells, the cooling plates will deform elastically and plastically, respectively, at least within a pre-defined operational pressure range of the battery cells. That is, the battery cells of the cell stack receive a pre-tension by the cell stack frame, for example, by an end plate of the cell stack frame pressing onto the cell stack, as explained above. The pre-tension refers to a pre-compression applied the cell stack. The battery cells are, thus, under an operational pressure which should be kept within a pre-defined range, depending on the type, size, and geometry of the battery cells, to ensure the intended operation of the battery cells. During charging and over their lifetime, however, the battery cells may swell due to aging effects, which – in known designs of battery systems – may increase the pressure inside the cell stack.

With the battery system according to embodiments of the present disclosure, however, this swelling of the battery cells is compensated at least in part by the elastically and plastically deformable compression structure. For example, while the battery cells swell up and, thus, increase in thickness, the cooling plates are compressed and, thus, decrease in thickness, for example, by the same amount or almost the same amount as the battery cells are increasing in thickness. During this compression, the cooling plates exert a constant or merely a slightly increasing pressure onto the battery cells over the entire compression range. That is, the compression structure is shaped or configured such that, in the designed compression/deformation range, it does not allow for a direct load transfer between the plate elements. In other words, although the battery cells may swell, the pressure inside the cell stack frame may remain substantially unchanged or at least within an ideal pressure range for cell operation. This results in a merely slight linear increasing force acting on the battery cells over a large range of compression distance/thickness reduction of the cooling plates and, thus, over a large range of age-related varying stack length of the cell stack. Thereby the cell stack may be safely kept within the ideal cell stack pre-tension range over its lifetime. In other words, the compression structure provides the battery system with a deformation characteristic which results in very similar compression forces independent of the cell stacks length deviations caused by production tolerances and/or swelling of the battery cells. In other words, the cell stack frame, due to the deformable cooling plates, may exert a compression force onto the cell stack in the relevant pre-tension force range for prismatic or pouch type cells. Thereby, the spring elements may provide for the elastic deformation, which compensates for thickness increase due to cell breathing (which may be of a smaller extent in thickness increase) while the connection portions may provide for the plastic deformation which compensates thickness increase due to cell ageing (which may be of a larger extent in thickness increase). Inevitable tolerances for both the elements of the cell stack as well as the elements of the cell stack frame can be compensated by the inherent deformation ability of the cooling plates. This may eliminate the need of additional shimming or other adjustment work during cell stacking. Further, any swelling (which may be, for example, due to ageing) of the battery cells of the cell stack may also be compensated. Further, because the compression structure is integrated into the cooling plates, the installation space is efficiently used as the cooling plates fulfill a double function of cooling the battery cells and as a deformable cell spacer. Compared to compression structures which only or primarily deform plastically, the present compression structures may prevent a steep elastic deformation at the beginning of the compression and at a later decompression which is achieved by the corrugated spring elements which flatten/weaken the spring characteristic.

According to one embodiment, the cooling structure further includes curved connecting elements extending about (or around) end sides of the battery cells and interconnecting neighboring cooling plates of the plurality of cooling plates such that the cooling structure has a meandering form. In other words, the cooling plates of the cooling structure may form, together with the connecting elements, a continuous passage or channel for the coolant through the battery system. Therein, the coolant may flow from an inlet through the cooling plates and connecting elements to an outlet. As mentioned above, the cooling plates and battery cells are alternatingly arranged. Two neighboring cooling plates along with its interconnecting connecting element may form a meander inside of which one battery cell of the plurality of battery cells may be arranged. The compression structure may extend through only the cooling plates or may also extend through the connecting elements. Such a meandering cooling structure may provide for simple construction, efficient cooling and – due to the compression structures –the intended deformation characteristic.

As mentioned above, the cell stack frame may include an end plate exerting pressure onto the cell stack. According to an embodiment, the end plate is shaped, at an inner side thereof facing an outermost one of the cooling plates, correspondingly to an adjacent side of the outermost cooling plate. For example, the end plate may be shaped correspondingly to an adjacent side of the cooling plate including the fluid inlet or the fluid outlet. Correspondingly may mean that the inner side of the end plate has a shape that corresponds to the shape of an outer surface of the outermost cooling plate such that a full-surface contact may be achieved between the end plate and the outermost cooling plate. The end plate may include a through-hole configured to receive the fluid inlet or fluid outlet such that the fluid inlet or fluid outlet may extend through the end plate. The end plate being formed correspondingly to the cooling plate may allow for an efficient transfer of compression force or pressure from the end plate onto the outermost cooling plate and thus onto the cell stack.

According to an embodiment, the cooling structure further includes a fluid inlet element arranged at a first end of the cell stack and a fluid outlet element arranged at a second end of the cell stack, and the cooling structure is configured for the passage of the coolant from the fluid inlet element, through the cooling chambers of the cooling plates, and out of the fluid outlet element. This embodiment may be suitable for the meandering cooling structure explained above, in which case the cooling structure may be configured for the feed-through of the coolant from the fluid inlet element, through the cooling chambers of the cooling plates and through the connecting elements, and out of the fluid outlet element. The coolant may thus flow in series through the cooling plates. In other words, a single coolant flow is achieved through the whole cell stack. In another embodiment, the cooling structure may include distribution channels extending along the stacking direction at the end side of the battery cells and connected to each of the cooling plates such that the coolant may flow parallel through the cooling plates. An outermost cooling plate of the plurality of cooling plates may include the fluid inlet and/or the fluid outlet. For example, a first outermost cooling plate at a first end of the cell stack may form the fluid inlet element and/or a second outermost cooling plate at a second end of the cell stack may form the fluid outlet element. Such a design of the cooling structure may provide for a simple design and effective cooling and deformation.

According to an embodiment, the cooling plates are extruded plates. That is, the cooling plates including the compression structure may be formed by an extrusion process. The whole cooling structure may be formed via an extrusion process. The cooling plates including the compression structure or the whole cooling structure may be made of aluminum. For example, when the cooling plates are formed by an extrusion process, the cooling plates or the whole cooling structure may be formed by aluminum extrusion. Producing the cooling plates, or the whole cooling structure including the cooling plates and the connecting elements (if present), as extrusion profiles is simple and efficient. The elements of the compression structure, such as cooling elements forming cooling channels inside the cooling chamber, may be formed in a constructively simple manner via extrusion. Also, such extrusion profiles provide for a stable construction while requiring a relatively small amount of material. Further, the cooling plates and the compression structures therein may be formed in a single production step.

According to an embodiment, the spring elements include V-shaped springs that interconnect the plate elements. Each of the V-shaped springs has two legs which have a corrugated shape. In other words, the legs have a wrinkled or creased shape. Again, in other words, the legs of the V-shaped springs meander or have a meandering form to flatten/weaken the spring characteristic of the springs, as explained above. The legs are configured to be elastically deformed in response to compression forces acting on the plate elements. In this embodiment, the connection portions of the compression structure connect the legs to the plate elements. As explained, the connection portions are configured to be plastically deformed in response to compression forces acting on the plate elements. In this embodiment, the compression structure is elastically deformable due to the V-shaped springs with legs having a corrugated shape. For example, the V-shaped springs each include two legs with a corrugated shape to be elastically deformed by cell breathing of the battery cells. The compression structure is plastically deformable due to the connection portions, for example, at least within an operational pressure range of the battery cells. That is, the ends of the V-shaped springs that form the connection portions receive the highest the bending stress such that plastic deformation occurs therein. This way, the battery system may compensate for cell thickness tolerances. In other words, the liquid cooling plate may include the connection portions between the two legs and/or between the legs and the outer plates to be plastically deformed to compensate for cell thickness tolerances within an operational pressure range of the battery cells. Thus, intended elastic-plastic deformation characteristic as explained above may be achieved in a simple and reliable manner.

According to an embodiment, the V-shaped springs are arranged one after the other in the same orientation. In other words, the V-shaped springs are aligned such that they point in the same direction. This may provide a constructively simple manner for the intended deformation characteristic.

According to an embodiment, the V-shaped springs are arranged in pairs of two with their open ends against each other. In other words, the two V-shaped springs of each pair point in opposite directions. This may provide in a constructively simple manner for the intended deformation characteristic, may provide for a more even pressure distribution than the V-shaped springs pointing in the same direction.

According to an embodiment, the corrugated shape of the V-shaped springs is configured such that when the cooling plate is fully compressed, the two legs of the V-shaped springs are nested inside each other while cooling channels through the cooling chamber are partially maintained inside the compressed cooling plate. In other words, the legs may have corrugated shapes that correspond to each other so that a protrusion of one of the legs protrudes into a receptacle of the other one of the legs. This allows for a high compression of the cooling plates albeit the compression structure so that the intended deformation characteristic may be achieved over a wide compression force.

According to an embodiment, the spring element(s) include a spring plate having a corrugated shape. The spring plate may extend in the same plane as the plate elements of the cooling plate. In other words, a main extension plane of the spring plate extends substantially parallel to the plate elements. Thus, as a compression structure, the corrugated spring plate may extend in-between the plate elements and may be connected to the plate elements at opposite sides via the connection portions. For example, the corrugated spring plate may be connected to the plate elements alternating between one side and the other. Such a compression structure may have a simple design/construction while providing the intended elastic-plastic deformation characteristic.

According to an embodiment, the plate elements are configured to bulge outwardly in a relaxed state and to be flattened in a compressed state to homogenize the pressure the plate elements apply onto adjacent battery cells. In other words, the plate elements are pre-tensioned against the compression force by having a bulged form, which may overcome an uneven pressure distribution along a vertical axis of the cooling plate, with peak pressures at where the connection portions contact the plate elements and lower pressures in between.

Embodiments of the present disclosure also provide an electric vehicle including a battery system according to embodiments of the present disclosure, such as a battery system explained above.

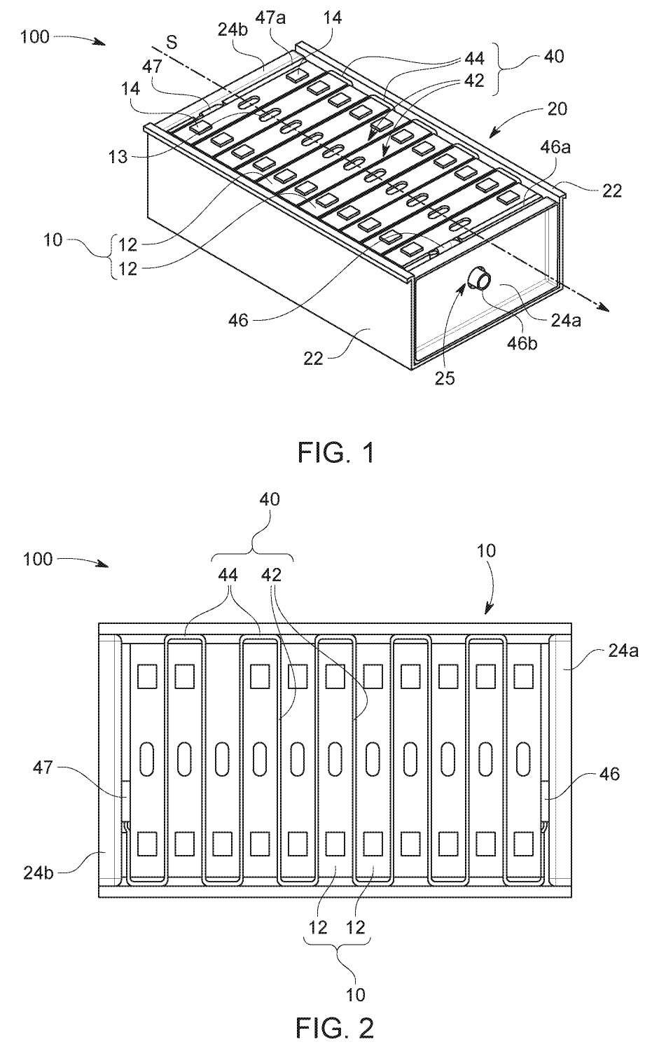

FIGS. 1-3 illustrate a battery system 100 according to an embodiment of the present disclosure. The battery system 100 includes a plurality of prismatic battery cells 12, which are stacked along a stacking direction S to form a cell stack 10. In some embodiments, the battery cells 12 may be, for example, pouch-type battery cells. Each of the battery cells 12 may include, at a top side (or top end) thereof, cell terminals 14 for electrical interconnection and a venting opening 13 for allowing gas and particles to exit the respective battery cell 12 during a thermal runaway.

The battery system 100 further includes a cell stack frame 20 that accommodates the cell stack 10. The cell stack frame 20 includes side wall elements 22 disposed parallel to the stacking direction S, a first end plate 24a disposed at a first end of the cell stack 10, and a second end plate 24b disposed at a second end of the cell stack 10. The end plates 24a, 24b exert pressure onto the cell stack 10 along the axis of the stacking direction S to compress the cell stack 10.

Further, the battery system 100 includes a cooling structure 40 including a plurality of cooling plates 42, each arranged between adjacent ones of the plurality of battery cells 12. For example, the battery cells 12 and cooling plates 42 may be alternately arranged. The cooling structure 40 further includes curved connecting elements 44 extending about lateral ends of the battery cells 12 and interconnecting neighboring cooling plates 42 such that the cooling structure 40 has a meandering form or shape. For example, the cooling structure 40 includes multiple meanders, each meander formed by two cooling plates 42 and the connecting element 44 connecting the two cooling plates 42, and one of the battery cells 12 is located inside each meander.

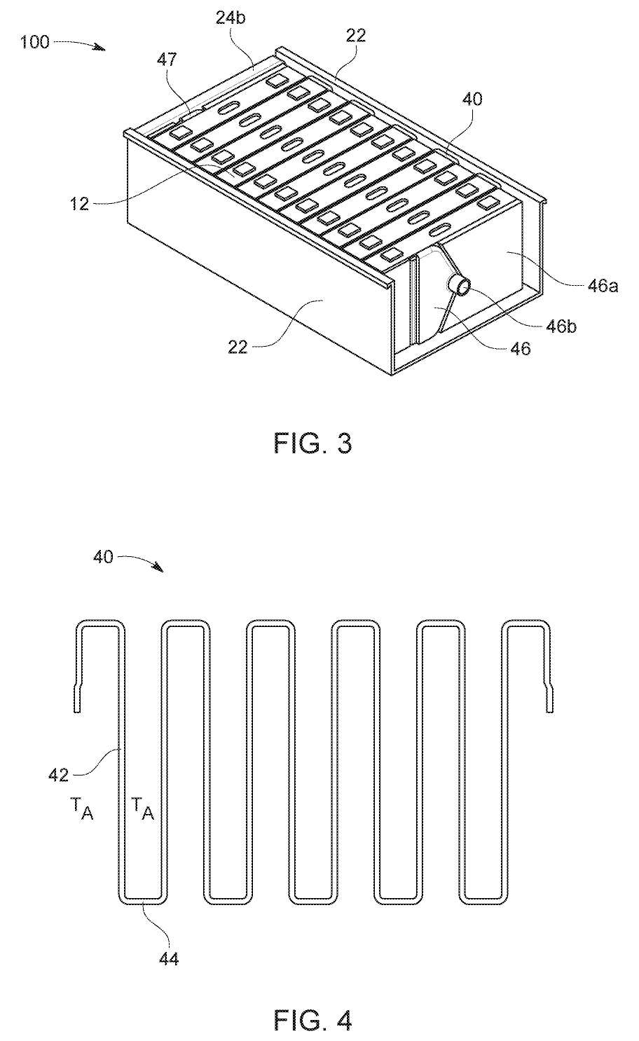

The cooling structure 40 further includes a fluid inlet element (e.g., a fluid inlet) 46 arranged at the first end of the cell stack 10 and a fluid outlet element (e.g., a fluid outlet) 47 arranged the second end of the cell stack 10. FIG. 3 shows the battery system 100 without the first end plate 24a to better show the fluid inlet element 46. As shown, the fluid inlet element 46 is plate-shaped and includes a distancing portion (e.g., an extension portion) 46a filling a gap between the outermost battery cell 12 and the first end plate 24a. The fluid outlet element 47 may also include a respective distancing portion 47a. An inner side of the first end plate 24a, which may be understood as forming an outermost cooling plate, facing the fluid inlet element 46 is shaped correspondingly to an adjacent side of the fluid inlet element 46. For example, the first end plate 24a flatly abuts the fluid inlet element 46 to provide full contact over the entire surface area the fluid inlet element 46, which improves transfer of the compression force/pressure onto the fluid inlet element 46. The first end plate 24a has a through-hole 25 through which an inlet 46b of the fluid inlet element 46 extends. Similarly, the second end plate 24b may have a through-hole through which an outlet of the fluid outlet element 47 extends.

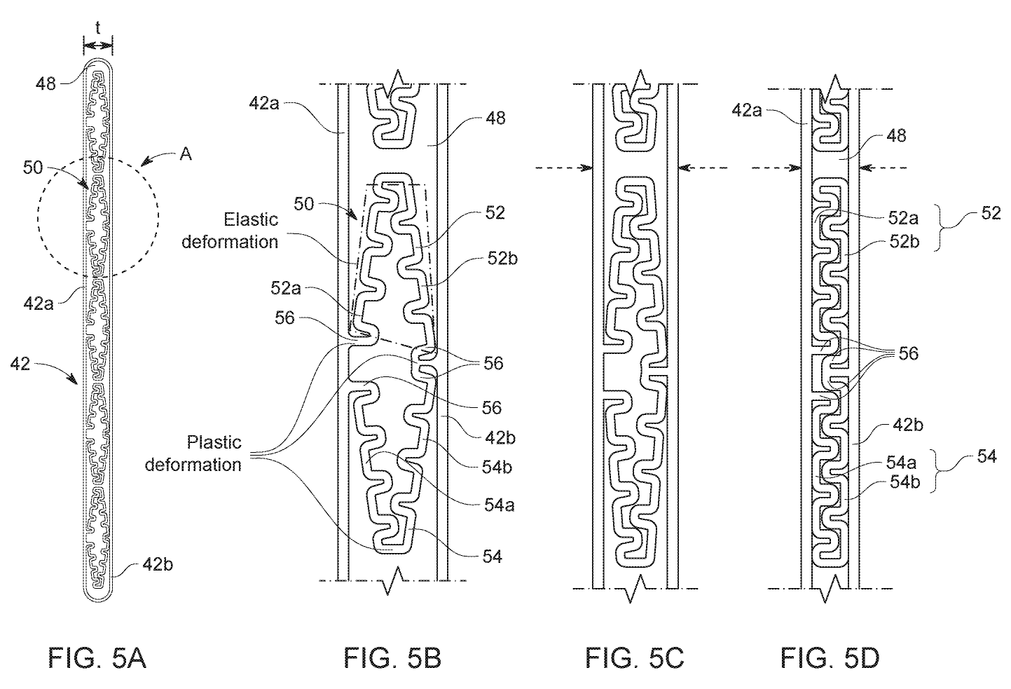

The cooling plates 42 each include two plate elements 42a, 42b with a cooling chamber 48 formed in-between for the feed-through (or passage) of coolant (see, e.g., FIG. 5). The cooling structure 40 is configured for the feed-through of coolant from the fluid inlet element 46, through the cooling chambers 48 formed inside the cooling plates 42 and through the connecting elements 44, and out of the fluid outlet element 47. The coolant flow may be reversed such that the fluid inlet element 46 may instead be the fluid outlet element and the fluid outlet element 47 may instead be the fluid inlet element. Thus, during regular operation of the battery system 100, coolant may flow through the meandering cooling structure 40, thereby cooling the battery cells 12 as they transfer heat to the cooling plates 42. The cooling plates 42 may therefore have a substantially full-surface contact to the adjacent battery cells 12 so that heat transfer is facilitated.

According to embodiments of the present disclosure, each of the cooling plates 42 further includes a compression structure 50 arranged inside the cooling chamber 48 (see, e.g., FIG. 5A). The compression structure 50 includes spring elements, which in the embodiment shown in FIG. 5A are V-shaped springs 52, 54 interconnecting the plate elements 42a, 42b. The V-shaped springs 52, 54 each include two legs 52a, 52b, 54a, 54b having a corrugated shape. The legs 52a, 52b, 54a, 54b and, thus, the V-shaped springs 52, 54 are configured to be elastically deformed when receiving compression forces acting on the plate elements 42a, 42b. Further, the compression structure 50 includes connection portions 56 connecting the legs 52a, 52b, 54a, 54b to the plate elements 42a, 42b. The connection portions 56 may be formed by ends of the legs 52a, 52b, 54a, 54b. The connection portions 56 are configured to be plastically deformed when receiving compression forces acting on the plate elements 42a, 42b. The V-shaped springs 52, 54 form cooling channels through which the coolant may flow through the cooling chamber 48. For example, the compression structure 50 does not hinder the flow of the coolant through the cooling chamber 48. As can be seen in FIG. 5A, the V-shaped springs 52, 54 are arranged in pairs of two with their open ends against each other.

The compression structure 50 is designed such that it is elastically and plastically deformed is response to compression forces acting on the plate elements 42a, 42b of the cooling plate 42. For example, the V-shaped springs 52, 54 and the connection portions 56 are deformable in reaction to a compression force or pressure which is indicated in FIGS. 5C and 5D via dashed arrows. In FIG. 5A, a cross-sectional view of the cooling plate 42 is shown in a non-compressed state. FIGS. 5B, 5C and 5D show the area A of FIG. 5A in more detail. As can be seen in FIG. 5B, the V-shaped springs 52, 54 and connection portions 56 are in a non-compressed state. In FIG. 5C, the cooling plate 42 is shown in a state where a first compression force acts on the cooling plate 42 compressing the same as indicated by the dashed arrows, causing a deformation of the compression structure 50. Specifically, the V-shaped springs 52, 54 are deformed elastically such that their legs 52a, 52b and 54a, 54b come closer to each other. The connection portions 56 are deformed plastically. Thus, a thickness t of the cooling plate 42 is reduced. In FIG. 5D, the cooling plate 42 is shown in a state where a second compression force acts upon the cooling plate 42, the second compression force being higher (or greater) than the first compression force. The cooling plate 42 is compressed even further such that the legs 52a, 52b of the V-shaped spring 52 are nested inside each other and the legs 54a, 54b of the V-shaped spring 54 are nested inside each other. Nevertheless, cooling channels in-between the legs 52a, 52b and legs 54a, 54b as well as between subsequent pairs of V-shaped springs 52, 54 are at least partially maintained allowing for continued flow of coolant. Thus, the thickness t of the cooling plate 42 is further reduced.

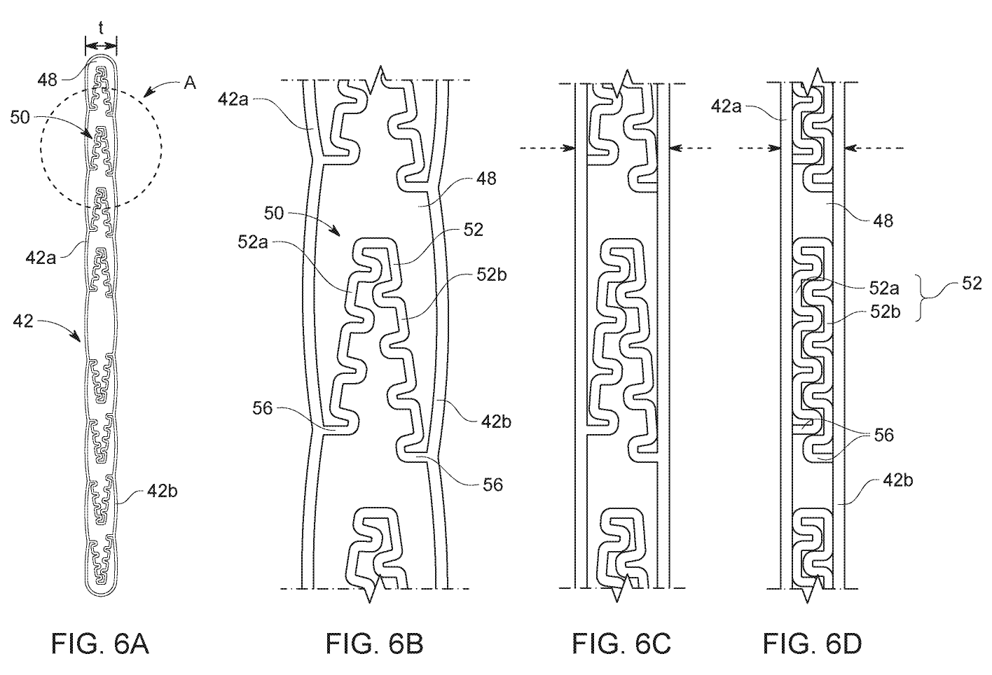

The embodiment shown in FIG. 6A differs from the embodiment shown in FIG. 5A in that the V-shaped springs 52 are arranged one after the other in the same orientation, for example, pointing in the same direction (upwards in FIG. 6A) and in that the plate elements 42a, 42b are bulged outwardly in a relaxed, non-compressed state (see, e.g., FIGS. 6A and 6B) and flattened in a compressed state (see, e.g., FIGS. 6C and 6D). As in the embodiment shown in FIGS. 5A-5D, three states of varying compression are shown, from a non-compressed state shown in FIG. 6B to a most compressed state shown in FIG. 6D. The bulged form homogenizes the pressure of the plate elements 42a, 42b onto adjacent battery cells 12. In other words, the bulged form may overcome an uneven pressure distribution along a vertical axis of the cooling plate 42, with peak pressures at where the connection portions 56 contact the plate elements 42a, 42b and lower pressures in between.

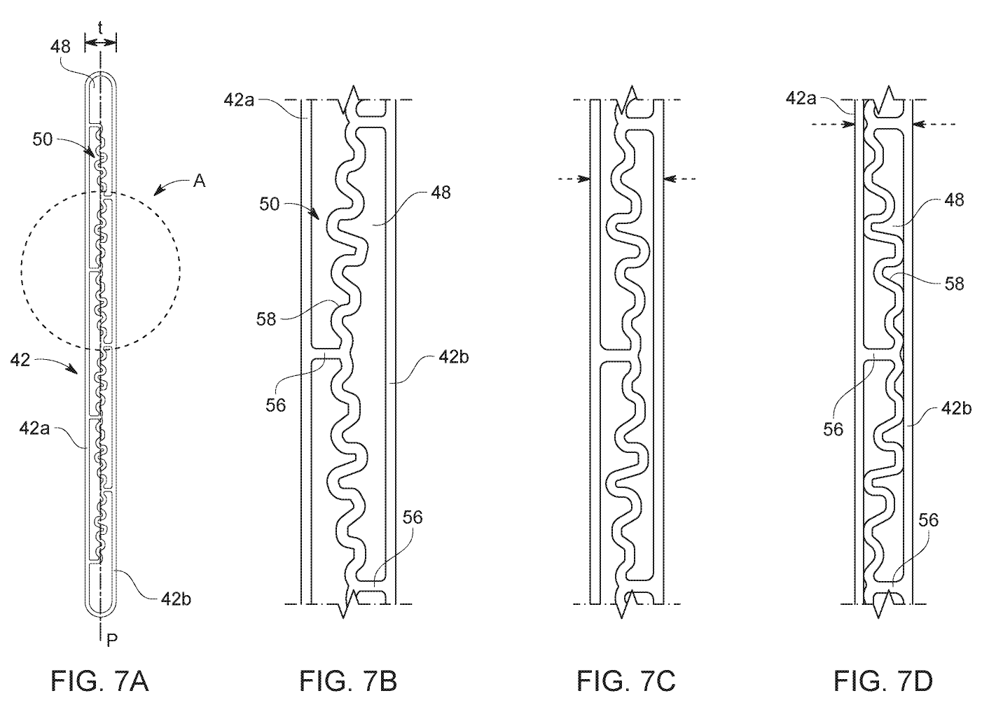

In the embodiment shown in FIGS. 7A-7D, a spring plate 58 is provided as a spring element, and the spring plate 58 has a corrugated shape. As shown, a main extension plane P of the spring plate 58 extends substantially parallel to the plate elements 42a, 42b. Thus, as a compression structure 50, the corrugated spring plate 58 may extend in-between the plate elements and may be connected to the plate elements 42a, 42b at opposite sides via the connection portions 56. As shown, the corrugated spring plate 58 may be connected to the plate elements 42a, 42b alternating between one side and the other. Such a corrugated spring plate 58 may have a simple design/construction while providing the intended elastic-plastic deformation characteristic.

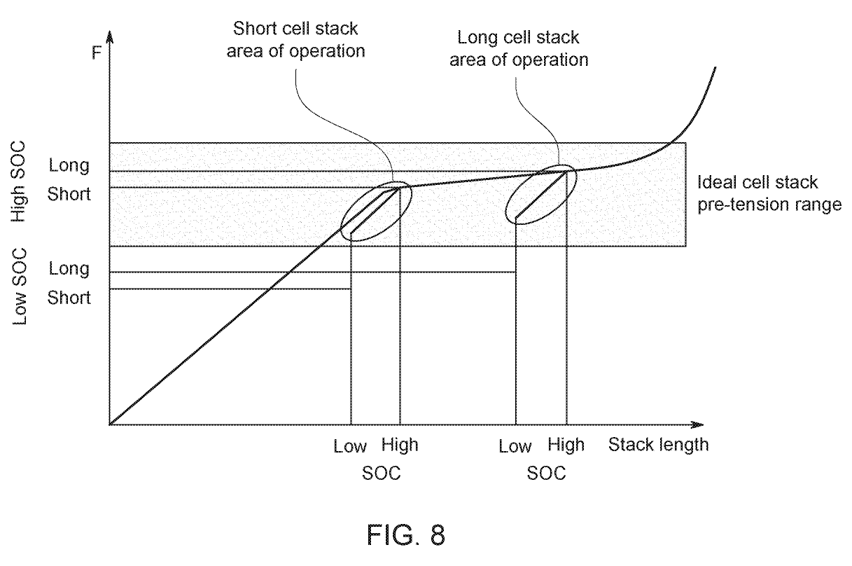

In the above-described embodiments, the compression structure 50 is designed such that it is elastically and plastically deformed in response to compression forces acting on the plate elements 42a, 42b of the cooling plate 42. For example, the compression structure 50 – and therefore the cooling plate 42 – is elastically and plastically deformable at least within an operational pressure range of the battery cells. In other words, the cooling plate has, due to the compression structure, an elastic-plastic deformation characteristic as shown in FIG. 8. The cooling structure 40 including the cooling plates 42, the connecting elements 44 and the compression structure 50 inside the cooling plates 42 may be formed via extrusion and may be, for example, aluminum extrusion profiles. The compression structures 50, in the designed compression/deformation range, do not allow for a direct load transfer between the plate elements 42a, 42b (until in an extreme position the legs 52a, 52b and the legs 54a, 54b lie flat against each other or the spring plate 58 contact the plate elements 42a, 42b directly).

Generally, the battery cells 12 of the cell stack 10 receive a pre-tension by the end plates 24a, 24b as mentioned above. The battery cells 12 are, thus, under an operational pressure which should be kept within a refence (or pre-defined) range depending on, for example, the type, size, and geometry of the battery cells to ensure the intended operation of the battery cells 12. The battery cells 12, however, swell and shrink when charging and discharging, respectively, which is known as cell breathing. Further, over their lifetime, the battery cells 12 may irreversibly swell due to aging effects which – in known designs of battery systems – may increase the pressure inside the cell stack. In the battery system 100 according to embodiments of the present disclosure, however, this swelling of the battery cells 12 is compensated at least in part by the plastically deformable compression structure 50. For example, while the battery cells 12 swell and, thus, increase in thickness, the cooling plates 42 are compressed and, thus, decrease in thickness.

During this compression, the cooling plates 42 exert not a steeply increasing pressure onto the battery cells as is the case with conventional cell spacers having a progressive deformation characteristic but exert substantially the same or a merely slightly increasing pressure over the entire compression range as shown in FIG. 8. That is, the compression structure 50 is shaped or designed – due to the corrugated shape – such that, in the designed compression/deformation range, it does not allow for a direct load transfer between the plate elements 42a, 42b.

FIG. 8 is a diagram describing a force F to elongation (e.g., cell stack length) ratio for the cooling plate 42 including the compression structure 50. The diagram shows, in the circled areas, the behavior of two cell stacks of different length dependent on their SOC (state of charge). The short cell stack may be a newly manufactured cell stack while the long cell stack may be the same cell stack having aged due to multiple charging-discharging-cycles. As explained previously, battery cells expand as they age. As shown, in case of both the short cell stack and the long cell stack, during cell breathing (e.g., between low SOC and high SOC), the exerted force F slightly increases linearly (elastic deformation) with the elongation of the battery cells 12 (and, thus, cell stack length) but stays within a window or range of an ideal cell stack pre-tension. This elastic deformation is achieved by the corrugated spring elements, such as the V-shaped springs 52, 54 due to their two legs 52a, 52b, 54a, 54b having a corrugated shape or the spring plate 58 having a corrugated shape. As shown in FIG. 8, the long cell stack area of operation, while being farther on the elongation/stack length axis, is only slightly higher on the force axis meaning that a plastic deformation characteristic is achieved. The compression force (and, thus, the pressure) therefore stays within the window or range of an ideal cell stack pre-tension even when the battery cells 12 swell due to ageing.

Further, at even higher elongation, the exerted force F increases progressively. For example, while the compression structure 50 may not allow for a direct load transfer between the plate elements 42a, 42b in the designed compression/deformation range, when the cooling structure 40 is compressed beyond its intended deformation, the compression structure 50 gets compressed, drastically altering the compression forces load path. The compression force F can then travel almost straight from one side to the other, that is, from one plate element 42a to the other plate element 42b, which leads to a stiffening of the compression structure 50 and prevents the total collapse of the cooling channels in the inside of the cooling structure 40, even if larger swelling forces/displacements than intended occur.

Thus, the end plates 24a, 24b, due to the cooling plates 42 with their internal compression structures 50, may exert basically a constant compression force onto the cell stack 10 independent of the age of the battery cells 12. Therefore, production tolerances as well as swelling forces/displacements of the battery cells 12 over the lifetime of the battery system 100 may be effectively compensated without an increase in pressure. The compression structures 50 are designed such that in low and high SOC, the battery cells 12 stay in the flat plateau area of the curve as shown in FIG. 8. The flat plateau may be provided by the plastic deformation of the connection portions 56 of the compression structures 50 of the cooling plates 42, as explained. Thus, the cell stack 10 may be kept in the optimum range of pressure for peak performance ensuring reliable and safe operation through all its life cycle until end of life.

### DESCRIPTION OF SOME REFERENCE SYMBOLS

10 cell stack
12 battery cells
13 venting openings
14 cell terminals
20 cell stack frame
22 side wall elements
24a first end plate
24b second end plate
25 through-hole
40 cooling structure
42 cooling plates
42a plate element
42b plate element
44 connecting elements
46 fluid inlet element
46a distancing portion 4
6b inlet
47 fluid outlet element
47a distancing portion
48 cooling chambers
50 compression structure
52 V-shaped spring
52a leg of V-shaped spring
52b leg of V-shaped spring
54 V-shaped spring
54a leg of V-shaped spring
54b leg of V-shaped spring
56 connection portions
58 spring plate
100 battery system
S stacking direction
P main extension plane

What is claimed is:

1. A battery system comprising:
a plurality of battery cells arranged in a cell stack;
a cell stack frame accommodating the cell stack and exerting a pressure onto the cell stack; and
a cooling structure comprising a plurality of cooling plates arranged between the battery cells, each cooling plate comprising:
two plate elements having a cooling chamber therebetween configured for passage of coolant; and
a compression structure arranged inside the cooling chamber, the compression structure comprising a spring element interconnecting the two plate elements to each other and a connection portion connecting the spring element to at least one of the plate elements,
wherein the spring elements having a corrugated shape and are configured to be elastically deformed in response to compression forces acting on the plate elements, and
wherein the connection portions are configured to be plastically deformed in response to compression forces acting on the plate elements.

2. The battery system as claimed in claim 1, wherein the cooling structure further comprises curved connecting elements extending about end sides of the battery cells and interconnecting neighboring ones of the cooling plates from among the plurality of cooling plates such that the cooling structure has a meandering form.

3. The battery system as claimed in claim 1, wherein the cell stack frame comprises an end plate exerting pressure onto the cell stack.

4. The battery system as claimed in claim 1, wherein the cooling structure further comprises a fluid inlet element arranged at a first end of the cell stack and a fluid outlet element arranged a second end of the cell stack, and
wherein the cooling structure is configured for the passage of the coolant from the fluid inlet element, through the cooling chamber of the cooling plates, and out of the fluid outlet element.

5. The battery system as claimed in claim 1, wherein the cooling plates are extruded plates.

6. The battery system as claimed in claim 1, wherein the cooling plates are made of aluminum.

7. The battery system as claimed in claim 1, wherein the spring element comprises a V-shaped spring interconnecting the plate elements,
wherein the V-shaped spring comprises two legs with a corrugated shape, the legs being configured to be elastically deformed in response to compression forces acting on the plate elements, and
wherein the connection portion connects the legs to the plate elements.

8. The battery system as claimed in claim 7, further comprising a plurality of the V-shaped springs arranged one after the other in the same orientation.

9. The battery system as claimed in claim 8, wherein the V-shaped springs are arranged in pairs of two with their open ends facing each other.

10. The battery system as claimed in claim 8, wherein the corrugated shape of the V-shaped springs is configured such that when the cooling plates are fully compressed, the two legs of the V-shaped springs are nested inside each other while cooling channels through the cooling chamber are partially maintained inside the compressed cooling plate.

11. The battery system as claimed in claim 1, wherein the spring elements comprise a spring plate having a corrugated shape, and
wherein a main extension plane of the spring plate extends substantially parallel to the plate elements.

12. The battery system as claimed in claim 1, wherein the plate elements are configured to bulge outwardly in a relaxed state and to be flattened in a compressed state to homogenize the pressure applied to adjacent ones of the battery cells.

13. An electric vehicle comprising the battery system as claimed in claim 1.
